(19) United States
(12) Patent Application Publication
(10) Pub. No.: US 2017/0140281 A1
(43) Pub. Date: May 18, 2017

(54) IDENTIFYING, FOR A SET OF DECISION RULES, ONE OR MORE DECISION RULES MISSING FROM THE SET OF DECISION RULES

(71) Applicant: INTERNATIONAL BUSINESS MACHINES CORPORATION, ARMONK, NY (US)

(72) Inventors: Stephane Hillion, VALBONNE (FR); Ulrich M. Junker, VALBONNE (FR); Thierry Kormann, VALBONNE (FR)

(21) Appl. No.: 14/943,219

(22) Filed: Nov. 17, 2015

(51) Int. Cl. G06N 5/04

(52) U.S. Cl. CPC G06N 5/045

(57) ABSTRACT

Aspects include identifying, for a set of decision rules, one or more decision rules missing from the set of decision rules, the one or more missing decision rules satisfying a set of limitations. A decision rule determines whether a decision is made for a case, and a limitation determines the cases for which a decision should be made. A constraint graph that represents the cases for which no rule of the set of rules makes a decision, and for which all limitations of the set of limitations are satisfied, is built. A missing case represented by the constraint graph is created, and a family description is created from the missing case. The family description is a set of cases for which no rule of the set of rules makes a decision. The one or more missing decision rules are then constructed from the family description.

### BACKGROUND

The present invention relates to identifying, for a set of decision rules, one or more decision rules missing from the set of decision rules.

### SUMMARY

In accordance with a first aspect of the invention there is provided a computer-implemented method of identifying, for a set of decision rules, one or more decision rules missing from the set of decision rules, the one or more missing decision rules satisfying a set of limitations, wherein a decision rule determines whether a decision is made for a case, and wherein a limitation determines the cases for which a decision should be made. The method includes receiving the set of decision rules, receiving the set of limitations and building a constraint graph that represents the cases for which no rule of the set of rules makes a decision, and for which all limitations of the set of limitations are satisfied. The method also includes constructing a missing case represented by the constraint graph, constructing a family description from the missing case, wherein the family description represents a set of cases for which no rule of the set of rules makes a decision and for which all limitations of the set of limitations are satisfied and constructing the one or more missing decision rules from the family description.

In accordance with a second aspect of the invention there is provided a computer system for identifying, for a set of decision rules, one or more decision rules missing from the set of decision rules, the one or more missing decision rules satisfying a set of limitations, wherein a decision rule determines whether a decision is made for a case, and wherein a limitation determines the cases for which a decision should be made, wherein the computer system comprises memory and a processor system configured to receive the set of decision rules, and store them in the memory, receive the set of limitations, and store them in the memory and to build a constraint graph that represents the cases for which no rule of the set of rules makes a decision, and for which all limitations of the set of limitations are satisfied. The processor is also configured to construct a missing case represented by the constraint graph, to construct a family description from the missing case, wherein the family description represents a set of cases for which no rule of the set of rules makes a decision and for which all limitations of the set of limitations are satisfied and to construct the one or more missing decision rules from the family description.

In accordance with a third aspect of the invention there is provided a computer program product for identifying, for a set of decision rules, one or more decision rules missing from the set of decision rules, the one or more missing decision rules satisfying a set of limitations, wherein a decision rule determines whether a decision is made for a case, and wherein a limitation determines the cases for which a decision should be made, the computer program product comprising a computer-readable storage medium having computer-readable program code embodied therewith, the computer-readable program code configured to perform a method. The method includes receiving the set of decision rules, receiving the set of limitations and building a constraint graph that represents the cases for which no rule of the set of rules makes a decision, and for which all limitations of the set of limitations are satisfied. The method also includes constructing a missing case represented by the constraint graph, constructing a family description from the missing case, wherein the family description represents a set of cases for which no rule of the set of rules makes a decision and for which all limitations of the set of limitations are satisfied and constructing the one or more missing decision rules from the family description.

It will of course be appreciated that features described in relation to one aspect of the present invention may be incorporated into other aspects of the present invention. For example, the method of the invention may incorporate any of the features described with reference to the computer system of the invention and vice versa.

### BRIEF DESCRIPTION OF THE SEVERAL VIEWS OF THE DRAWINGS

Embodiments of the present invention will now be described, by way of example only, with reference to the following drawings in which:

FIG. 1 is a schematic diagram of system comprising a computer system in accordance with an embodiment of the invention;

FIG. 2 is a schematic diagram of system comprising a computer system in accordance with another embodiment of the invention;

FIGS. 3a, 3b and 3c are diagrams illustrating the sets of rules and limitations of an example decision policy;

FIG. 4a is a flowchart showing the operation of the computer system of FIG. 1 to generate all restricted missing rules for all relevant scopes;

FIG. 4b is a flowchart showing in more detail the operation of the computer system of FIG. 1 when generating all restricted missing rules for a particular non-explored scope;

FIG. 4c is a flowchart showing in more detail the operation of the computer system of FIG. 1 when determining a missing case of the non-explored scope that satisfies the set of limitations of the restricted decision policy;

FIG. 4d is a flowchart showing in more detail the operation of the computer system of FIG. 1 when generalising the family description cases to a most-general condition that satisfies the set of limitations; and

FIG. 5 is a diagram illustrating a restricted missing decision rule generated for the example decision policy of FIGS. 3a to 3c.

### DETAILED DESCRIPTION

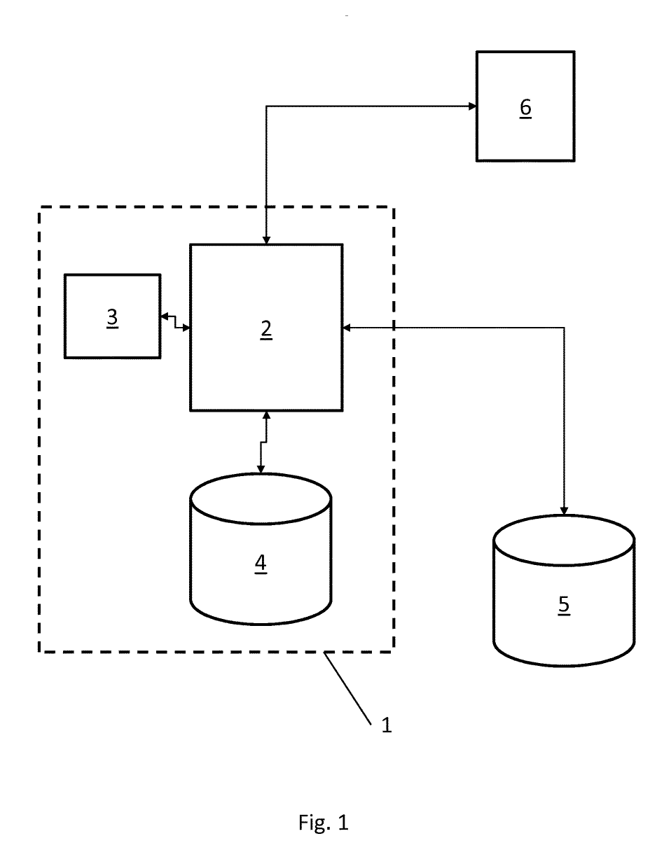

FIG. 1 shows a computer system in accordance with an embodiment of the invention.

The computer system 1 shown in FIG. 1 is a server system, comprising a processor system 2, and volatile random-access memory 3 in communication with the processor system 2. It will be appreciated that in different embodiments of the invention the processor system may comprise a single processor, multiple processors, and may be solely for the use of the computer system 1 or shared with other computer systems in a “virtual” environment, for example. Similarly, in different embodiments the memory 3 may be a single memory area or comprises multiple separate memory areas, and may be shared with other computer systems. In some embodiments, in addition to the memory 3 the processor system 2 will have its own internal cache memory.

The computer system 1 further comprises a persistent memory 4 in communication with the processor system 2, which may be a hard disk or the like. The computer system 1, and the processor system 2 thereof in particular, is also in communication with an external persistent memory 5. In different embodiments the external persistent memory 5 may be local to the computer system 1 or in a remote location, and may be directly connected to the computer system 1, connected via a local area network or via a non-local network such as the Internet, for example.

The computer system 1 is in communication with a remote computer device 6, which may for example another server or a personal computer (PC). As discussed below, the rules etc. processed by the computer system 1 in accordance with embodiments of the invention are sent to the computer system 1 by the remote computer device 6.

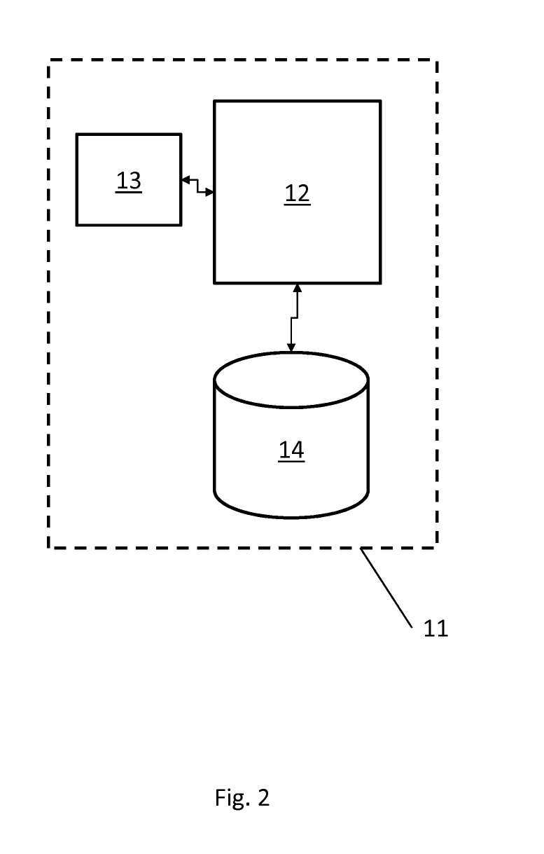

FIG. 2 shows a computer system in accordance with another embodiment of the invention. In this embodiment, the computer system 11 is a PC, comprising a processor system 12 in communication with random-access memory 13 and persistent memory 14. In this embodiment, the rules etc. processed by the computer system 1 in accordance with embodiments of the invention are provided on the computer system 11 itself, for example because the computer system 1 is itself operating using the rules that are being analysed. On other embodiments, the rules may be directly entered by a user using an input device (e.g. keyboard, etc.), downloaded from a remote location over a network, or obtained from a removable memory device such as a USB memory stick, for example.

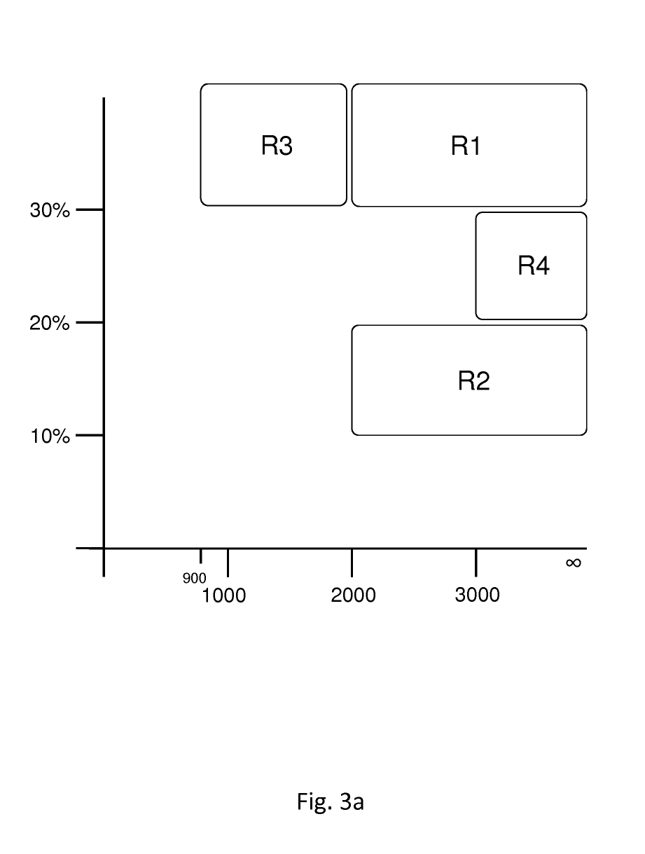

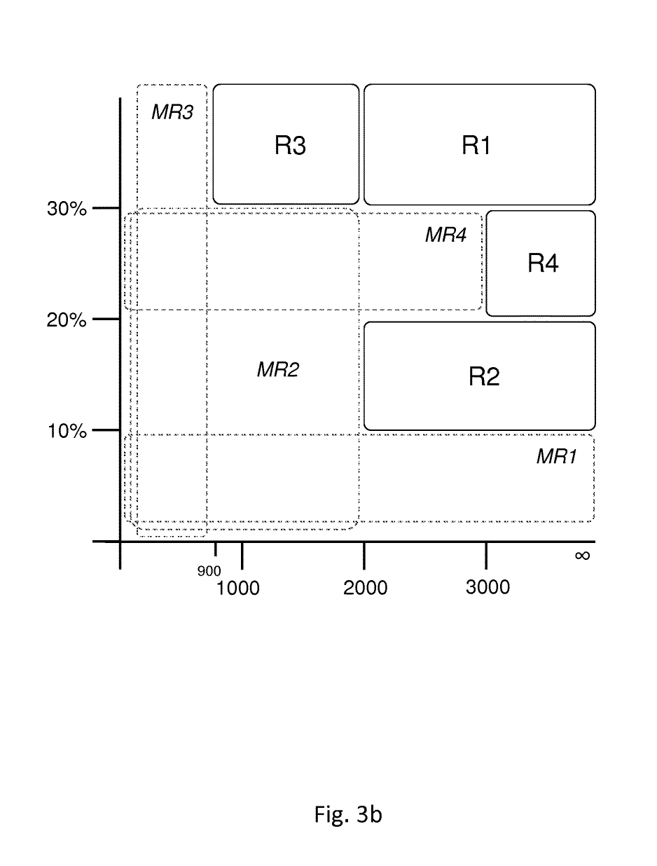

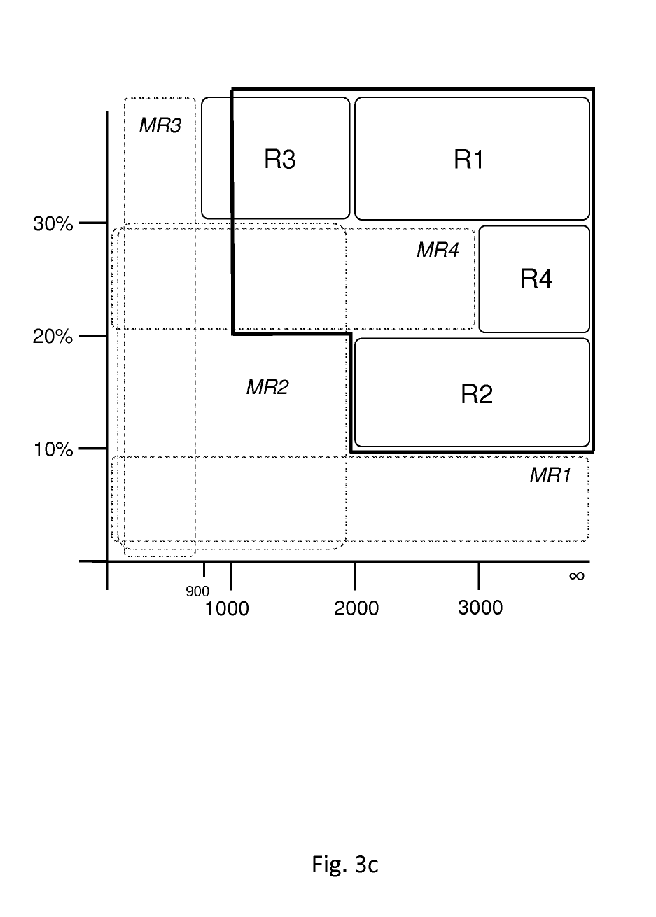

An example to illustrate some principles used by some embodiments of the invention is now described with reference to FIGS. 3a to 3c. In the example a decision policy has been defined, which is used to make decisions about approving loans. In particular, the decision policy approves or rejects given loan requests depending on the requested amount and the overall debt rate.

The decision policy can be represented by condition-action rules, which match objects of particular types and with particular attributes, which are known as “cases”. The set of cases considered by a rule is known as its “scope”. In the present example, the rules match objects that are of type “loan request”, and the condition parts of the rules limit the loan requests to which the rules are applicable. These cases that the conditions of the rules match can be characterised in terms of the values of the relevant attributes, i.e. the amount and the debt rate in the example. The action parts of the rules then either accept or reject the loan requests.

The decision policy of the present example consists of the following four rules:

### Rule R1:

set ‘Loan1’ to a loan request;

if the amount of ‘Loan1’ is at least $2000 and the debt rate of ‘Loan1’ is at least 30%

then reject ‘Loan1’;

### Rule R2:

set ‘Loan1’ to a loan request;

if the amount of ‘Loan1’ is at least $2000 and the debt rate of ‘Loan1’ is at least 10% and the debt rate of ‘Loan1’ is less than 20%

then accept ‘Loan1’;

### Rule R3:

set ‘Loan1’ to a loan request;

if the amount of ‘Loan1’ is at least $900 and the amount of ‘Loan1’ is less than $2000 and the debt rate of ‘Loan1’ is at least 30%

then accept ‘Loan1’;

### Rule R4:

set ‘Loan1’ to a loan request;

if the amount of ‘Loan1’ is at least $3000 and the debt rate of ‘Loan1’ is at least 20% and the debt rate of ‘Loan1’ is less than 30%

then reject ‘Loan1’;

The decision policy is represented in FIG. 3a, in which the rules are represented by regions on a graph with axes representing the attributes of the cases that match the conditions of the rules. The x-axis represents the loan amount, while the y-axis represents the debt rate. Thus, the above rules result in the regions R1, R2, R3 and R4 shown in FIG. 3a.

Not all possible cases are matched by the decision policy, as can be seen from the empty area on the bottom left of the graph of FIG. 3a. An example of a non-matched case is a loan request of an amount of $1000 and a debt rate of 10%. Example rules that cover these missing cases, as might be generated by a conventional completeness analyser, are shown in FIG. 3b. The example missing rules MR1, MR2, MR3 and MR4 have a scope and a rule condition in the same way as ordinary rules, but have a placeholder in their action part as their actions are not yet defined. The example missing rules are as follows:

### Rule MR1:

set ‘Loan1’ to a loan request;

if the debt rate of ‘Loan1’ is less than 10%

then <action>

### Rule MR2:

set ‘Loan1’ to a loan request;

if the amount of ‘Loan1’ is less than $2000 and the debt rate of ‘Loan1’ is less than 30%

then <action>

### Rule MR3:

set ‘Loan1’ to a loan request;

if the amount of ‘Loan1’ is less than $900

then <action>

### Rule MR4:

set ‘Loan1’ to a loan request;

if the amount of ‘Loan1’ less than $3000 and the debt rate of ‘Loan1’ is at least 20% and the debt rate of ‘Loan1’ is less than 30%

then <action>

As can be seen, a conventional completeness analyser (i.e. a conventional system used to generate missing rules) may generate several missing rules to complete a decision policy. The number of missing rules generated will grow as the number of original rules and the number of attributes impacting the applicability of those rules grows. Depending on the decision policy, not all of the reported missing rules may constitute issues in the rule set that need to be addressed. For example, it may considered that loan requests of an amount of $1000 and a debt rate of 10% are not of interest, as loans of that type will never be issued, and such requests can always be discarded without any informed decision whether to accept or reject such a loan needing to be made. As such, such requests do not ever need to be handled by the decision policy.

The existence of such cases that do not need to be addressed can be captured by defining a set of limitations for the decision policy, to give a restricted decision policy. If all the cases treated by a missing rule are beyond of the limitations of a restricted decision policy, then such a missing rule is irrelevant and ideally should not be returned by any process that generates missing rules. Similarly, if some but not all of the cases treated by a missing rule are beyond of the limitations of a restricted policy, then the applicability of the missing rule ideally should restricted to the limitations before being returned. However, it will be appreciated that in embodiments of the invention, missing rules that are only partially within such limitations may be generated.

In the present example, two limitations are defined for the decision policy. Each limitation has a scope that indicates the objects and their types to which the limitation is applicable, and stipulates a condition for cases that are relevant, i.e. the attributes for loan requests that are considered to be relevant.

A first limitation L1 indicates that the decision policy covers loan requests having an amount of at least $1000 and a debt rate of at least 20%, Limitation L1, the amount must be at least $1000 and the debt rate must be at least 20%.

A second limitation L2 indicates that the decision policy additionally covers loan requests having an amount of at least $2000 and a debt rate of at least 10%, Limitation L2, the amount must be at least $2000 and the debt rate must be at least 10%

Hence, a restricted decision policy having these limitations covers a case if the scope of the case contains all objects of one of the limitations and satisfies the condition of this limitation.

FIG. 3c indicates the boundaries of the limitations using bold lines. As can be seen, each of the rules R1, R2 and R4 is within the limitations, as is a part of rule R3. Missing rules MR1 and MR3 are entirely beyond the boundaries of the limitations and are thus not required. Missing rules MR2 and MR4 cover missing cases within the boundaries of the limitations as well as missing cases outside the boundaries of the limitations, and hence their conditions should be restricted to be within the boundaries of the limitations.

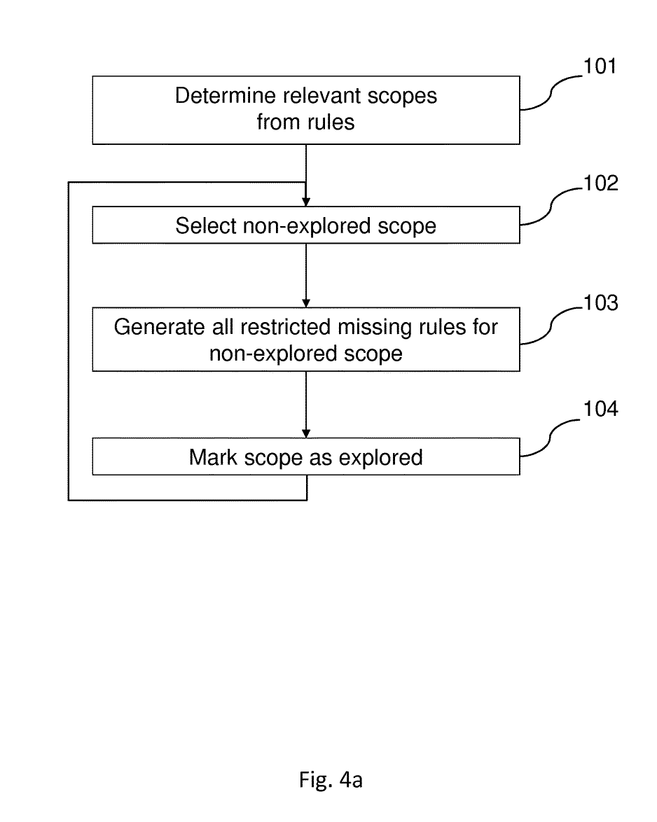

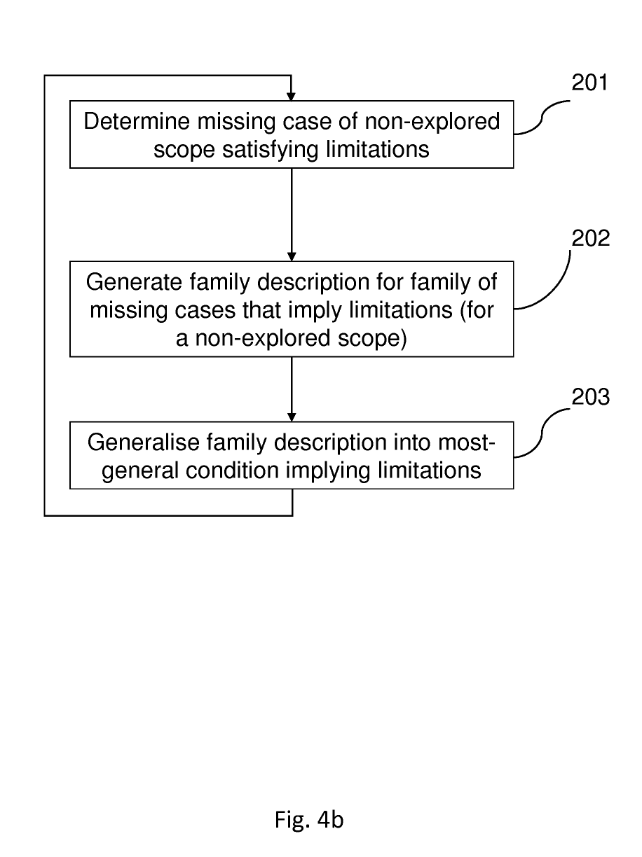

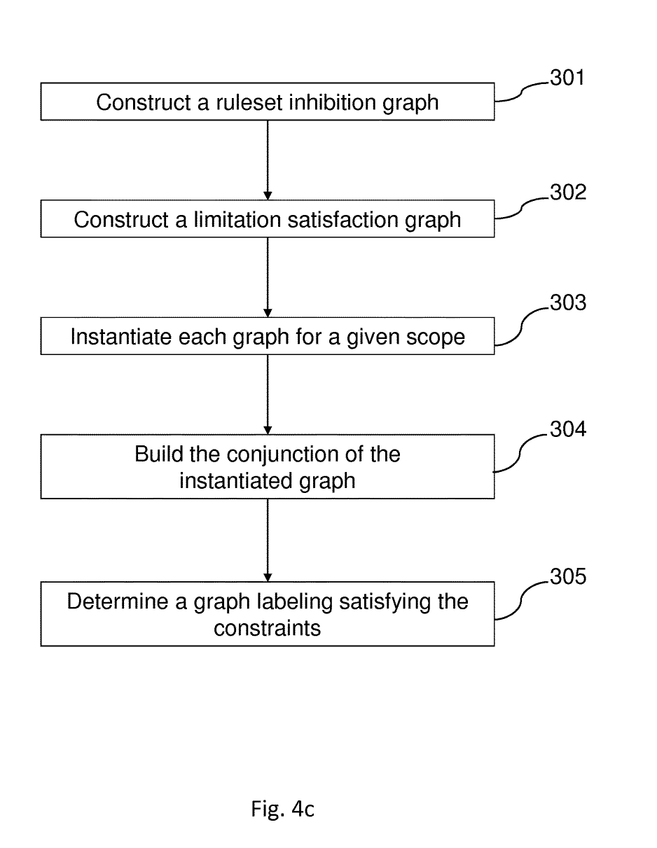

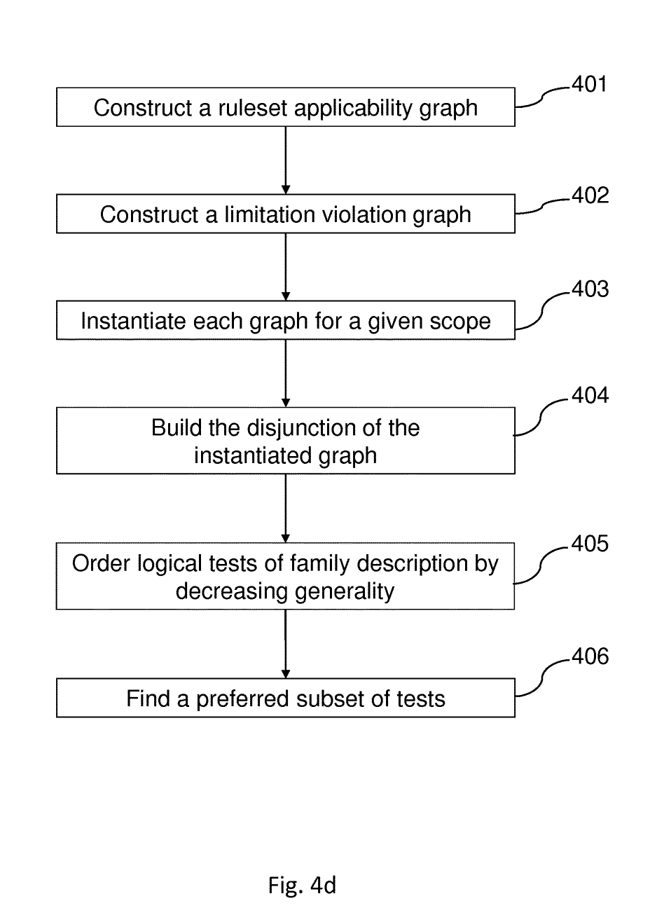

The operation of the computer system 1, to find decision rules missing from a decision policy but that also satisfy a set of limitations for the decision policy, is now described with reference to the flowcharts of FIGS. 4a to 4d.

FIG. 4a is flowchart showing the operation of the computer system 1 to generate all restricted missing rules for all relevant scopes. The computer system 1 receives from the remote computer device 6 a restricted decision policy, which comprises a set of decision rules and a set of limitations. The set of decision rules and set of limitations rule may be stored in the persistent memory 4 and/or external persistent memory 5, depending for example on size limitations.

Initially, the computer system 1, and in particular the processor system 2 thereof, extracts all relevant scopes from the set of rules (block 101). The scopes are put in a scope store, which is stored in the persistent memory 4. Initially, all scopes are marked as non-explored.

Next, a non-explored scope is selected from the scope store (block 102). If scopes of smaller size are selected first, restricted missing rules will be generated that match a minimal set of objects, and so in the present embodiment this is done. However, it will be appreciated that the scopes can be selected in different orders in alternative embodiments, but doing so may lead to more than the minimal number of missing rules being generated than are required.

All restricted missing rules for the selected scope are generated (block 103), as described in more detail below, and stored in a restricted missing rule store, which again is stored in the persistent memory 4. The scope is then marked as explored (block 104). The process is iterated until all scopes in the scope store have been explored (blocks 102 and subsequent blocks again).

The result is a set of restricted missing rules, stored in the restricted missing rule store in the persistent memory 4. These rules can then be used to complete the rule set of the restricted decision policy in any appropriate way, for example by being reviewed by a user who selects the appropriate actions for the restricted missing rules, and then adds them to the original rule set.

To illustrate the operation of the computer system 1, it is now applied to the above example. In the example, all of the rules R1, R2, R3 and R4 have the same scope, which consists of a single object of type “loan request”. Objects of the scope are named in a canonical way. For example, the name can be composed of the type name and a number. Hence, initially a single scope consisting of object LoanRequest1 is determined (block 101). This scope is selected (block 102), and all restricted missing rules for this scope are generated (block 103). The scope is marked as explored (block 104). As this was the only scope, all scopes are now marked as explored, and so the set of restricted missing rules for this scope is the set of restricted missing rules for the whole rule set, and the process is complete.

FIG. 4b is a flowchart showing in more detail the operation of the computer system 1 when generating all restricted missing rules for a particular non-explored scope (i.e. block 103 above). First, a missing case of the non-explored scope that satisfies the set of limitations of the restricted decision policy is determined (block 201), as described in more detail below, taking into account both the rule set of the decision policy and any already-generated restricted missing rules stored in the restricted missing rule store.

The missing case is then used to generate a family description that describes a family of missing cases that have the non-explored scope, satisfy the set of limitations (or in equivalent logical terms, imply the limitations in the set of limitations), and evaluate all relevant logical tests in the same way as the given missing case (block 202). The relevant tests include the logical tests occurring in the rule conditions of the set of rules of the decisions policy and any already-generated restricted missing rules, as well as the logical tests occurring in the limitations of the set of limitations.

The generated family description is then generalised into a restricted missing rule of the given scope, that has a most-general condition that satisfies the set of limitations (block 203), as described in more detail below. Only the originally received set of rules is taken into account, and so a restricted missing rule may be generated that overlaps with already generated missing rules.

The process is then iterated until there are no further missing cases that satisfy the set of limitations can be found (block 201 and subsequent blocks, again), which will be either because no such case exists or because a predetermined timeout period is exceeded. The result is the set of restricted missing rules of the given scope which is stored in the restricted missing rule store, as described above.

Considering the application of this aspect of the process to the above example, the following missing case that satisfied the set of limitations may be found (block 201), amount of LoanRequest1=$2000 and debt rate of LoanRequest1=20%

This missing case is transformed into a family description for a family of missing cases that satisfy the limitations (block 202). To do this, all atomic logical tests occurring in the conditions of the set of rules of the decision policy are extracted. If such a test is satisfied by the missing case, the test is added to the family description. If such a test is violated by the missing case, the logical negation of the test to the family description. For the missing case above, this leads to the following tests being added to the family description:

the amount of LoanRequest1 is at least $2000;

the debt rate of LoanRequest1 is less than 30%;

the debt rate of LoanRequest1 is at least 10%;

the debt rate of LoanRequest1 is at least 20%;

the amount of LoanRequest1 is at least $900; and

the amount of LoanRequest1 is less than $3000.

Further, all atomic logical tests occurring in the limitations of the set of limitation are extracted and added (or their negations are added) to the family description similarly to the above. For the missing case above, this leads to the following additional test being added to the family description:

the amount of LoanRequest1 is at least $1000

The family description thus includes any case of the given scope that satisfies the seven logical tests listed above.

This family description is then generalised to a most-general condition that satisfies the set of limitations (block 203), by removing irrelevant tests. A missing rule is constructed that has the selected scope and that has the conjunction of logical tests in the family description as condition part. The action of the missing rule is a placeholder indicating that the action still needs to be determined by the policy maker. For example, the considered family description is generalised into the following restricted missing rule:

Rule RMR1: definitions

set ‘LoanRequest1’ to a loan request;

if the amount of ‘LoanRequest1’ is at least $1000 and the amount of ‘LoanRequest1’ is less than $3000 and the debt rate of ‘LoanRequest1’ is at least 20% and the debt rate of ‘LoanRequest1’ is less than 30%
then <action>

As can be seen, one of the tests in the condition of this restricted missing rule comes from the set of limitations, namely the following test:

the amount of ‘Loan1’ is at least $1000

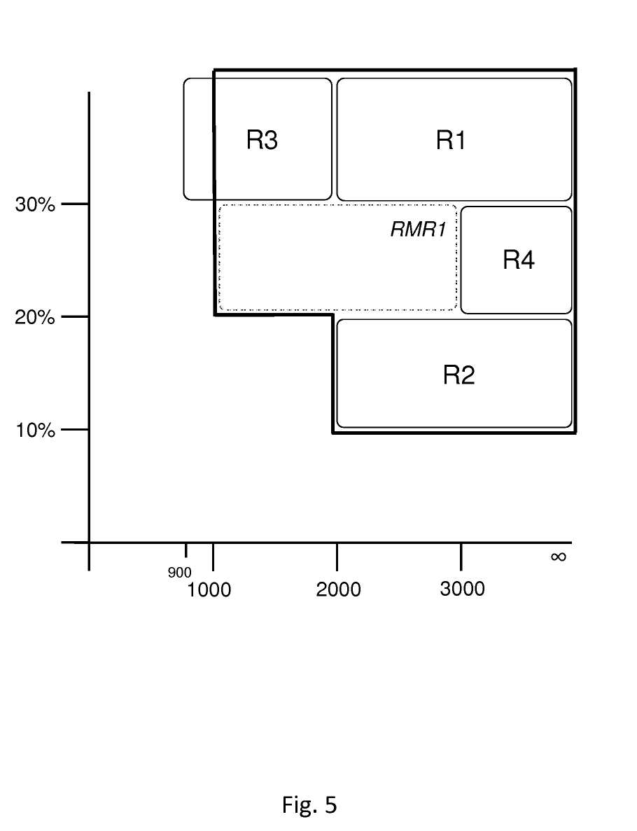

By only generalising to a most-general condition that satisfies the set of limitations, it is ensured that the constructed restricted missing rule will only cover cases that satisfy the set of limitations. This is guaranteed by the method of construction, as explained in more detail below. FIG. 5 shows the generated restricted missing rule added to the decision policy, and in particular shows that it is within the boundaries of the limitations.

FIG. 4c is a flowchart showing in more detail the operation of the computer system 1 when determining a missing case of the non-explored scope that satisfies the set of limitations of the restricted decision policy (i.e. block 201 above). First, a ruleset inhibition graph is built (block 301), for the set of rules of the decision policy as well as for any restricted missing rules generated in previous iterations. This constraint graph describes all cases that do not make any of these rules applicable. To do this, the constraint graph has nodes representing the negations of rule conditions of the set of rules and restricted missing rules. The whole ruleset inhibition graph represents a conjunction of universally quantified constraints.

A limitation satisfaction graph is then built (block 302). This constraint graph describes all cases that satisfy the set of limitations. The limitation satisfaction graph represents a disjunction of existentially quantified constraints.

The ruleset inhibition graph and the limitation satisfaction graph are then instantiated for the given scope (block 303). Each universally quantified constraint is replaced by a conjunction of instances of this constraint, namely one for each combination of objects from the scope that can instantiate the variables of the quantified constraint. Each existentially quantified constraint is replaced by a disjunction of instances of this constraint, namely one for each combination of objects from the scope that can instantiate the variables of the quantified constraint.

The conjunction of the instantiated ruleset inhibition graph and the instantiated limitation satisfaction graph is then built (block 304). This constraint graph describes the missing cases that have the given scope and that satisfy the set of limitations.

A labelling of the constraint graph that satisfies the operations of the graph nodes and that labels the root node with “true” is then determined (block 305). It will be appreciated that this block may use any appropriate constraint solving techniques including search and inference methods, of which many are well-known. If such a graph labelling is successfully determined, a description of a missing case is extracted from the graph labelling and returned. If on the other hand the constraint solver determined that no such labelling exists or a predetermined timeout is exceeded, then a message is returned indicating that no missing case that satisfies the set of limitations could be found for the given scope.

Considering the application of this aspect of the process to the above example, first a ruleset inhibition graph that represents the following constraint is constructed (block 301), all of the following conditions are true:

for all loan requests x: the amount of x is less than $2000 or the debt rate of x is less than 30%;

for all loan requests x: the amount of x is less than $2000 or the debt rate of x less than 10% or the debt rate of x is at least 20%;

for all loan requests x: the amount of x is less than $900 or the amount of x is at least $2000 or the debt rate of x is less than 30%; and

for all loan requests x: the amount of x is less than $3000 or the debt rate of x is less than 20% or the debt rate of x is at least 30%.

A limitation satisfaction graph that represents the following constraint is then built (block 302), one of the following conditions is true:

there exists a loan request x such that the amount of x is at least $1000 and the debt rate of x is at least 20%; and

there exists a loan request x such that the amount of x is at least $2000 and the debt rate of x is at least 10%.

The graphs are then instantiated for the given scope (block 303), i.e. for the scope which consists of the single object LoanRequest1. All occurrences of the variable x are replaced by the object LoanRequest1. The conjunction of the instantiated graphs is then built (block 304), which represents the following constraint:

all of the following conditions are true:

the amount of LoanRequest1 is less than $2000 or the debt rate of LoanRequest1 is less than 30%;

the amount of LoanRequest1 is less than $2000 or the debt rate of LoanRequest1 less than 10% or the debt rate of LoanRequest1 is at least 20%;

the amount of LoanRequest1 is less than $900 or the amount of LoanRequest1 is at least $2000 or the debt rate of LoanRequest1 is less than 30%;

the amount of LoanRequest1 is less than $3000 or the debt rate of LoanRequest1 is less than 20% or the debt rate of LoanRequest1 is at least 30%; and one of the following conditions is true:

the amount of LoanRequest1 is at least $1000 and the debt rate of LoanRequest1 is at least 20%; and

the amount of LoanRequest1 is at least $2000 and the debt rate of LoanRequest1 is at least 10%.

A labelling of this graph that satisfies the operations of the graph nodes and that labels the root node by “true” is then determined (block 305). For example, the labelling may choose the label $2000 for the node representing the amount of LoanRequest1 and the label 20% for the node representing the debt rate of LoanRequest1. A constraint solver will be able to extend to a complete graph labelling (unless the predetermined timeout is exceeded). In order to extract a missing case from the labelling, the labels of all graph nodes that represent attribute values of the objects of the case are determined. In other words, the labels of the graph nodes representing the amount of LoanRequest1 and the debt rate of LoanRequest1 are extracted, to give the following description of a missing case: amount of LoanRequest1=$2000 and debt rate of LoanRequest1=20%

FIG. 4d is a flowchart showing in more detail the operation of the computer system 1 when generalising the family description into a most-general condition that satisfies the set of limitations (i.e. block 203 above). As mentioned above, the generalisation is done by removing irrelevant tests.

First, a ruleset applicability graph for the set of rules of the decision policy (but not for any restricted missing rules generated) is built (block 401). This constraint graph describes all cases that make some of these rules applicable. The constraint graph therefore has nodes representing the rule conditions. The whole ruleset applicability graph represents a disjunction of existentially quantified constraints.

A limitation violation graph is then built (block 402). This constraint graph describes all cases that do not satisfy the set of limitations. The limitation violation graph represents a conjunction of universally quantified constraints.

The ruleset applicability graph and the limitation violation graph are then instantiated for the given scope (block 403), in the same way as described above (i.e. for block 303).

The disjunction of the instantiated ruleset applicability graph and the instantiated limitation violation graph is then built (block 404). This constraint graph describes the cases of the given scope that are treated by the rules or that are beyond of the given limitations.

Separately, the logical tests that make up the family description (as constructed in block 202 described above) are ordered by decreasing generality (block 405). A preferred subset of tests is then determined (block 406), using the constraint graph and the ordered logical tests. In an embodiment of the invention, the preferred subset of tests is a preferred conflict, as described in QUICKXPLAIN: Preferred Explanations and Relaxations for Over-Constrained Problems, Junker U., Proceedings of the Association for the Advancement of Artificial Intelligence (AAAI) 2004. However, it will be appreciated that other methods of determining the preferred subset of tests can be used in alternative embodiments.

The preferred conflict is determined using the ordered logical tests as a foreground constraint and the instantiated constraint graph resulting as background constraint. The preferred conflict is computed by examining the logical tests in the foreground in the inverse order starting from the last (i.e. least general) one. In each block, the logical test being examined is removed from the foreground on a trial basis. A constraint solver is used to determine whether the reduced foreground and the background have a common solution. If they have a common solution, then there is a case that belongs to the family described by the reduced foreground and that makes a rule applicable or that does not satisfy the set of limitations. As such a case must not be included in a family of missing cases that satisfy the set of limitations, the logical test being examined is put back into the foreground. If, on the other hand, the reduced foreground and the background do not have a common solution, there is no case that belongs to the family described by the reduced foreground and that makes some rule applicable or that does not satisfy the set of limitations. In this case, the logical test unnecessarily restricts the family of missing cases which satisfy the set of limitations. For that reason, the logical test is permanently removed from the foreground. This procedure is repeated until all logical tests have been examined. The resulting foreground contains logical tests that describe an enlarged family of missing cases within limitations, and is used to construct a restricted missing rule for the given scope.

Considering the application of this aspect of the process to the above example, a ruleset applicability graph is built that represents the following constraint (block 401), one of the following conditions is true:

there exists a loan request x such that the amount of x is at least $2000 and the debt rate of x is at least 30%;

there exists a loan request x such that the amount of x is at least $2000 and the debt rate of x is at least 10% and the debt rate of x is less than 20%;

there exists a loan request x such that the amount of x is at least $900 and the amount of x is less than $2000 and the debt rate of x is at least 30%; and

there exists a loan request x such that the amount of x is at least $3000 and the debt rate of x is at least 20% and the debt rate of x is less than 30%.

A limitation violation graph is then built that represents the following constraint (block 402), all of the following conditions are true:

for all loan requests x: the amount of x is less than $1000 or the debt rate of x is less than 20%; and

for all loan requests x: the amount of x is less than $2000 or the debt rate of x is less than 10%.

The graphs are instantiated for the given scope (block 403), i.e. the scope which consists of the single object LoanRequest1. All occurrences of the variable x are replaced by the object LoanRequest1. The disjunction of the instantiated graphs is then constructed (block 404). The result represents the following constraint, one of the following conditions is true:

the amount of LoanRequest1 is at least $2000 and the debt rate of LoanRequest1 is at least 30%;

the amount of LoanRequest1 is at least $2000 and the debt rate of LoanRequest1 is at least 10% and the debt rate of LoanRequest1 is less than 20%;

the amount of LoanRequest1 is at least $900 and the amount of LoanRequest1 is less than $2000 and the debt rate of LoanRequest1 is at least 30%;

the amount of LoanRequest1 is at least $3000 and the debt rate of LoanRequest1 is at least 20% and the debt rate of LoanRequest1 is less than 30%; or all of the following conditions are true:

the amount of LoanRequest1 is less than $1000 or the debt rate of LoanRequest1 is less than 20%; and

the amount of LoanRequest1 is less than $2000 or the debt rate of LoanRequest1 is less than 10%.

The logical tests that describe the given family of missing cases which satisfy the set of limitations is then reordered (block 405), so that the logical tests are ordered in decreasing generality. For example, those logical tests may initially be ordered as follows:

the amount of LoanRequest1 is at least $2000;

the debt rate of LoanRequest1 is less than 30%;

the debt rate of LoanRequest1 is at least 10%;

the debt rate of LoanRequest1 is at least 20%;

the amount of LoanRequest1 is at least $900;

the amount of LoanRequest1 is less than $3000; and

the amount of LoanRequest1 is at least $1000.

It can be seen that the logical tests are not ordered in decreasing generality. For example, the logical test “the amount of LoanRequest1 is at least $1000” is more general than the logical test “the amount of LoanRequest1 is at least $2000” as it is satisfied by more cases, but does not precede this second logical test. After the logical tests are reordered in decreasing generality the following ordering may be produced, for example (it will be appreciated that multiple suitable orderings may be possible):

the amount of LoanRequest1 is at least $900;

the amount of LoanRequest1 is at least $1000;

the amount of LoanRequest1 is at least $2000;

the debt rate of LoanRequest1 is less than 30%;

the debt rate of LoanRequest1 is at least 10%;

the debt rate of LoanRequest1 is at least 20%; and

the amount of LoanRequest1 is less than $3000.

Each logical test is then examined to see if it makes a rule of the set of rules applicable, or does not satisfy the set of limitations (block 406). First, the last one in the ordering is examined, i.e. the logical test “the amount of LoanRequest1 is less than $3000”. It is determined that the removal of this logical test will include cases that are covered by the set of rules of the decision policy, and so this logical test is not removed permanently. Similarly, the removal of the logical test “the debt rate of LoanRequest1 is at least 20%” is determined to include cases that are covered by the set of rules of the decision policy, and so it is not removed permanently.

In contrast, it is determined that the logical test “the debt rate of LoanRequest1 is at least 10%” can be removed permanently, as it makes no difference to the set of cases covered by the set of logical tests, and so cannot change the applicable rules or limitations satisfied.

Similarly to above, it is determined that the logical text “the debt rate of LoanRequest1 is less than 30%” cannot be permanently removed.

The removal of the logical test “the amount of LoanRequest1 is at least $2000” enlarges the family of cases covered by the set of logical tests, but only adds missing cases that are satisfied by the set of limitations. For this reason, this test is permanently removed, and results in a generalisation of the family description.

At this stage, the family description consists of the following logical tests, with the first and second logical tests remaining to be examined:

the amount of LoanRequest1 is at least $900;

the amount of LoanRequest1 is at least $1000;

the debt rate of LoanRequest1 is less than 30%;

the debt rate of LoanRequest1 is at least 20%; and

the amount of LoanRequest1 is less than $3000.

The removal of the logical test “the amount of LoanRequest1 is at least $1000” leads to the following family description:

the amount of LoanRequest1 is at least $900;

the debt rate of LoanRequest1 is less than 30%;

the debt rate of LoanRequest1 is at least 20%; and

the amount of LoanRequest1 is less than $3000.

This family description includes cases that do not satisfy the set of limitations, such as:

amount of LoanRequest1=$900; and

debt rate of LoanRequest1=20%.

In other words, this case satisfies the instantiated limitations violation graph, and so the logical test is not removed. It will be appreciated that this logical test originates from the set of limitations, rather than from the set of rules of the decision policy.

Finally, the removal of the logical test “the amount of LoanRequest1 is at least $900” does not enlarge the family, and so is permanently removed, so giving the following final preferred subset of logical tests:

the amount of LoanRequest1 is at least $1000;

the debt rate of LoanRequest1 is less than 30%;

the debt rate of LoanRequest1 is at least 20%; and

the amount of LoanRequest1 is less than $3000.

This family description describes a most-general family of missing cases that satisfy the set of limitations. A missing rule builder creates a missing rule of the given scope that treats those missing cases. It creates a definition part according to the given scope, a condition part that corresponding to the four logical tests, and a placeholder for the action part:

Rule RMR1:

set ‘LoanRequest1’ to a loan request;

if the amount of ‘LoanRequest1’ is at least $1000 and the amount of ‘LoanRequest1’ is less than $3000 and the debt rate of ‘LoanRequest1’ is at least 20% and the debt rate of ‘LoanRequest1’ is less than 30%;

then <action>

This missing rule, which is a restricted missing rule as it satisfied the set of limitations, is returned as the result of the missing rule generaliser. As can be seen, this is the same Rule RMR1 discussed above, and shown in FIG. 5.

As the considered example only has a single scope, all scopes have now been explored, and so the process is completed.

While the present invention has been described and illustrated with reference to particular embodiments, it will be appreciated by those of ordinary skill in the art that the invention lends itself to many different variations not specifically illustrated herein.

For example, it will be appreciated that the various sets of data that the computer system 1 receives could be in received in different orders, and similarly the various graphs and the like could be generated in different orders, as long as in each case the required data was available.

It will also be appreciated that while an example is given for decisions made for a loan application system, the invention is equally applicable to many other types of system. For example, the invention could be applied to a web shopping system, in which rules were using to generate pricing offers for certain combinations of items in a shopping cart. Limitations could include that combinations of items with a total value below a particular amount were of no interest, for example. Similarly, the invention could be applied to a computer security system, in which a set of rules made decisions about the security of a system. The limitations could that the security configuration of certain devices, for example devices with less than a certain level of privileges, were of no interest, for example.

It will further be appreciated that while, for example, the described embodiments of the invention require all limitations of the set of limitations to be satisfied by any generated missing decision rule, in other embodiments only one limitation of the set of limitations could be required to be satisfied. In such embodiments the above-described process could be performed, but using as the set of limitations for the process a single limitation derived from the original set of limitations. In particular, the derived single limitation could be the disjunction of the limitations in the original set of limitations, for example. In alternative embodiments, the process could be modified appropriately to only require one limitation of the set of limitations to be satisfied.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method of identifying, for a set of decision rules, one or more decision rules missing from the set of decision rules, the one or more missing decision rules satisfying a set of limitations, wherein a decision rule determines whether a decision is made for a case, and wherein a limitation determines the cases for which a decision should be made, comprising:
receiving the set of decision rules;
receiving the set of limitations;
building a constraint graph that represents the cases for which no rule of the set of rules makes a decision, and for which all limitations of the set of limitations are satisfied;
constructing a missing case represented by the constraint graph;
constructing a family description from the missing case, wherein the family description represents a set of cases for which no rule of the set of rules makes a decision and for which all limitations of the set of limitations are satisfied; and
constructing the one or more missing decision rules from the family description.

2. A computer-implemented method as claimed in claim 1, wherein building the constraint graph comprises:
building a ruleset inhibition graph that represents the cases for which no rule of the set of rules makes a decision; and building a limitation satisfaction graph that represents the cases for which a limitation of the set of limitations is satisfied;
and wherein the constraint graph is built from a conjunction of the ruleset inhibition graph and the limitation satisfaction graph.

3. A computer-implemented method as claimed in claim 2, wherein the missing case is constructed from the constraint graph by determining a labelling of the constraint graph that satisfies operations of the graph nodes.

4. A computer-implemented method as claimed in claim 1, wherein the family description is constructed from logical tests that occur in the rules of the set of rules, and logical tests that occur in the limitations of the set limitations, that are satisfied by the missing case.

5. A computer-implemented method as claimed in claim 1, wherein constructing the missing decision rule from the family description comprises:
building a ruleset applicability graph that represents the cases for which a rule of the set of rules makes a decision;
building a limitation violation graph that represents the cases for which no limitation of the set of limitations is satisfied; and
building a second constraint graph from the disjunction of the ruleset inhibition graph and the limitation satisfaction graph.

6. A computer-implemented method as claimed in claim 5, wherein the missing decision rule is constructed from the family description by selecting the logical tests of the family description for which no case that satisfies all the logical tests satisfies the second constraint graph.

7. A computer-implemented method as claimed in claim 6, wherein the logical tests of the family description are selected in reverse order of generality.

8. A computer-implemented method as claimed in claim 1, wherein the method is repeated until no further missing decision rules are identified.

9. A computer system for identifying, for a set of decision rules, one or more decision rules missing from the set of decision rules, the one or more missing decision rules satisfying a set of limitations, wherein a decision rule determines whether a decision is made for a case, and wherein a limitation determines the cases for which a decision should be made, wherein the computer system comprises memory and a processor system and is arranged to:
receive the set of decision rules, and store them in the memory;
receive the set of limitations, and store them in the memory;
use the processor system to build a constraint graph that represents the cases for which no rule of the set of rules makes a decision, and for which all limitations of the set of limitations are satisfied; use the processor system to construct a missing case represented by the constraint graph;
use the processor system to construct a family description from the missing case, wherein the family description represents a set of cases for which no rule of the set of rules makes a decision and for which all limitations of the set of limitations are satisfied; and
use the processor system to construct the one or more missing decision rules from the family description.

10. A computer system as claimed in claim 9, arranged to build the constraint graph by:
building a ruleset inhibition graph that represents the cases for which no rule of the set of rules makes a decision; and
building a limitation satisfaction graph that represents the cases for which a limitation of the set of limitations is satisfied; and
wherein it is further arranged to build the constraint graph from a conjunction of the ruleset inhibition graph and the limitation satisfaction graph.

11. A computer system as claimed in claim 10, arranged to construct the missing case from the constraint graph by determining a labelling of the constraint graph that satisfies operations of the graph nodes.

12. A computer system as claimed in claim 9, arranged to construct the family description from logical tests that occur in the rules of the set of rules, and logical tests that occur in the limitations of the set limitations, that are satisfied by the missing case.

13. A computer system as claimed in claim 9, arranged to construct the missing decision rule from the family description by:
building a ruleset applicability graph that represents the cases for which a rule of the set of rules makes a decision;
building a limitation violation graph that represents the cases for which no limitation of the set of limitations is satisfied; and
building a second constraint graph from the disjunction of the ruleset inhibition graph and the limitation satisfaction graph.

14. A computer system as claimed in claim 13, arranged to construct the missing decision rule from the family description by selecting the logical tests of the family description for which no case which satisfies all the logical tests satisfies the second constraint graph.

15. A computer system as claimed in claim 14, arranged to select the logical tests of the family description in reverse order of generality.

16. A computer system as claimed in claim 9, arranged to repeat identifying missing decisions until no further missing decision rules are identified.

17. A computer program product for identifying, for a set of decision rules, one or more decision rules missing from the set of decision rules, the one or more missing decision rules satisfying a set of limitations, wherein a decision rule determines whether a decision is made for a case, and wherein a limitation determines the cases for which a decision should be made, the computer program product comprising a computer-readable storage medium having computer-readable program code embodied therewith, the computer-readable program code configured to perform:
receiving the set of decision rules;
receiving the set of limitations;
building a constraint graph that represents the cases for which no rule of the set of rules makes a decision, and for which all limitations of the set of limitations are satisfied; constructing a missing case represented by the constraint graph;
constructing a family description from the missing case, wherein the family description represents a set of cases for which no rule of the set of rules makes a decision and for which all limitations of the set of limitations are satisfied; and
constructing the one or more missing decision rules from the family description.

18. A computer program product as claimed in claim 17, wherein building the constraint graph comprises:
building a ruleset inhibition graph that represents the cases for which no rule of the set of rules makes a decision; and
building a limitation satisfaction graph that represents the cases for which a limitation of the set of limitations is satisfied; and wherein the constraint graph is built from a conjunction of the ruleset inhibition graph and the limitation satisfaction graph.

19. A computer program product as claimed in claim 17, wherein constructing the missing decision rule from the family description comprises:
building a ruleset applicability graph that represents the cases for which a rule of the set of rules makes a decision;
building a limitation violation graph that represents the cases for which no limitation of the set of limitations is satisfied; and building a second constraint graph from the disjunction of the ruleset inhibition graph and the limitation satisfaction graph.

20. A computer program product as claimed in claim 19, wherein the missing decision rule is constructed from the family description by selecting the logical tests of the family description for which no case that satisfies all the logical tests satisfies the second constraint graph.
